(19) United States
(12) Patent Application Publication
(10) Pub. No.: US 2013/0173369 A1
(43) Pub. Date: Jul. 4, 2013

(54) SYSTEM FOR MANAGING LOYALTY PROGRAM PARTNERS

(71) Applicant: Mark J. Krolick, Naperville, IL (US)

(72) Inventor: Mark J. Krolick, Naperville, IL (US)

(73) Assignee: Mileage Plus Holdings, LLC., Chicago, IL (US)

(21) Appl. No.: 13/340,009

(22) Filed: Dec. 29, 2011

(51) Int. Cl. G06Q 30/02

(52) U.S. Cl. 705/14.17

(57) ABSTRACT

Some embodiments include a computer-implemented method for disseminating a business lead to a partner of a loyalty program. In some embodiments, the method includes completing a sales transaction with a customer over a telecommunications network, where the customer is a member of the loyalty program. The method can also include depositing, via an electronic transmission, a first quantity of loyalty currency in an electronic account associated with the customer, wherein the deposit is given to the customer for completion of the sales transaction, wherein the loyalty currency is issued by the loyalty program. The method can also include transmitting an electronic notification to the partner, wherein the notification includes information about services purchased via the sales transaction and contact information associated with the customer.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, Mileage Plus Holdings, LLC.

### FIELD

Embodiments of the inventive subject matter relate generally to the field of data processing, and more particularly to the field of processing business transaction information.

### BACKGROUND

Many airlines have loyalty programs. Such loyalty programs typically award loyalty program members with frequent-flier miles (also referred to as “miles”, “points”, etc.) when members purchase airline tickets, and other goods and services. Members can redeem the frequent-flier miles for additional airline tickets, rental cars, hotel stays, and more. Thus, frequent-flier miles are like “credits” for use in purchasing airline tickets, and other goods and services. Typically, frequent-flier miles are only redeemable at one airline (i.e., the airline that awarded the miles). As members accrue and redeem miles with a particular airline, the members typically develop loyalty to that airline. As a result, airline loyalty programs are constantly looking for new and creative ways to award and redeem frequent-flier miles.

### BRIEF DESCRIPTION OF THE FIGURES

The present invention is illustrated by way of example and not limitation in the Figures of the accompanying drawings in which:

FIG. 1 is a conceptual diagram illustrating transactions, according to some embodiments of the inventive subject matter.

FIG. 2 is a block diagram illustrating a loyalty program server and other computerized components, according to embodiments of the invention.

FIG. 3 is a conceptual diagram illustrating operations for processing partnership offers, according to some embodiments of the invention.

FIG. 4 shows a portion of a partnership database, according to some embodiments.

FIG. 5 is a conceptual diagram illustrating transactions between the customer, loyalty program, and a loyalty program partner.

FIG. 6 is a conceptual diagram illustrating transactions between the customer, loyalty program, and a loyalty program partner.

FIG. 7 is a flow diagram illustrating operations for selling loyalty currency to loyalty program partners.

FIG. 8 is a block diagram showing some embodiments of a loyalty program server.

FIG. 9 depicts an example loyalty program server, according to some embodiments of the inventive subject matter.

### DESCRIPTION OF THE EMBODIMENTS

### Introduction

Loyalty programs may award loyalty currency when customers purchase airline tickets, make purchases on credit cards associated with the loyalty program, purchase rental cars though loyalty program promotions, purchase hotel stays through loyalty program promotions, etc. Customers may redeem the accrued miles for travel items and/or merchandise. Typically, there is a limited universe of suppliers that a loyalty program will allow for redemption of travel items. This universe usually includes the loyalty program's supplier (e.g., an airline) and any partner suppliers. Some customers may find the loyalty program's redemption options to be limiting or otherwise not attuned to their specific desired itinerary.

After customers redeem loyalty currency for airline tickets, the airline issues reservations and the loyalty program typically ceases to service the customers for other pre-travel needs, other than minor changes to reservation (e.g., departure times and/or dates, etc.). Hence, for additional travel services, customers typically find travel goods and services on their own, outside the loyalty system. Some customers would appreciate targeted travel offers that enable them to redeem or accrue miles, and to book necessary travel services. To fill such a need, some embodiments of the inventive subject matter facilitate targeted travel offers, and loyalty mile redemption and accrual opportunities. More specifically, in some embodiments, after a customer books an airline ticket, the airline's loyalty system notifies a service partner about the customer's travel booking. In turn, the service partner contacts the customer with service offers that coincide with the customer's travel itinerary, and that include redemption/accrual opportunities. For example, a rental car company may contact the customer, offering a rental car for certain travel days. The offer may also award miles for every dollar spent with the rental car company. Alternatively, the loyalty program may send the offer on behalf of the rental car company. In any case, embodiments of the inventive subject matter facilitate transactions between a loyalty program's customers and the loyalty program's business partners.

### Transactions

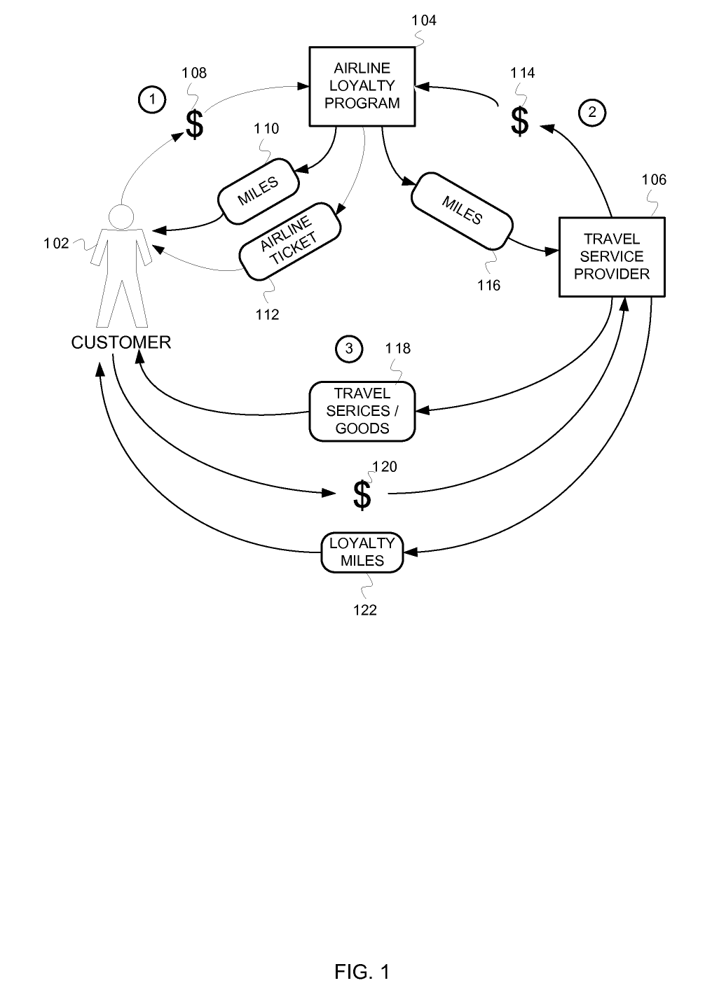

As noted above, embodiments of the inventive subject matter facilitate transactions between a loyalty program, its customers, and its business partners. FIG. 1 is a conceptual diagram illustrating transactions between a loyalty program, its customers, and its business partners. FIG. 1 shows a customer 102, airline loyalty program 104, and travel service partner 106. The airline loyalty program 104 can be associated with an airline, such as United Airlines, Inc. The travel service provider 106 is a business partner of the airline loyalty program, and can be a rental car provider, hotel operator, tour operator, etc.

Transactions between the airline loyalty program 104 and customers 102 involve an exchange of money, airline tickets, and miles. As shown, the customer 102 pays money 108 to the airline loyalty program 104 in exchange for an airline ticket 112. For each purchase, the airline loyalty program 104 may award miles 110 to the customer 102. In other transactions, the customer 102 can redeem the miles for various goods and services, such as airline tickets, rental car services, hotel services, merchandise, etc. Conceptually, money (108), miles (110), and airline tickets (112) flow between the customer 102 and the airline loyalty program 104. Although not shown, the airline loyalty program 104 may provide an electronic interface (e.g., a website) (not shown) through which the customer 102 can purchase airline tickets and conduct other transactions. The airline loyalty program 104 may also maintain electronic accounts for each customer, where the accounts keep track of miles that have accrued, airline tickets that have been purchased, money spent, and other information associated with such transactions. Furthermore, the airline loyalty program 104 may be capable of receiving monies (108) from credit card companies and other electronic payment facilities.

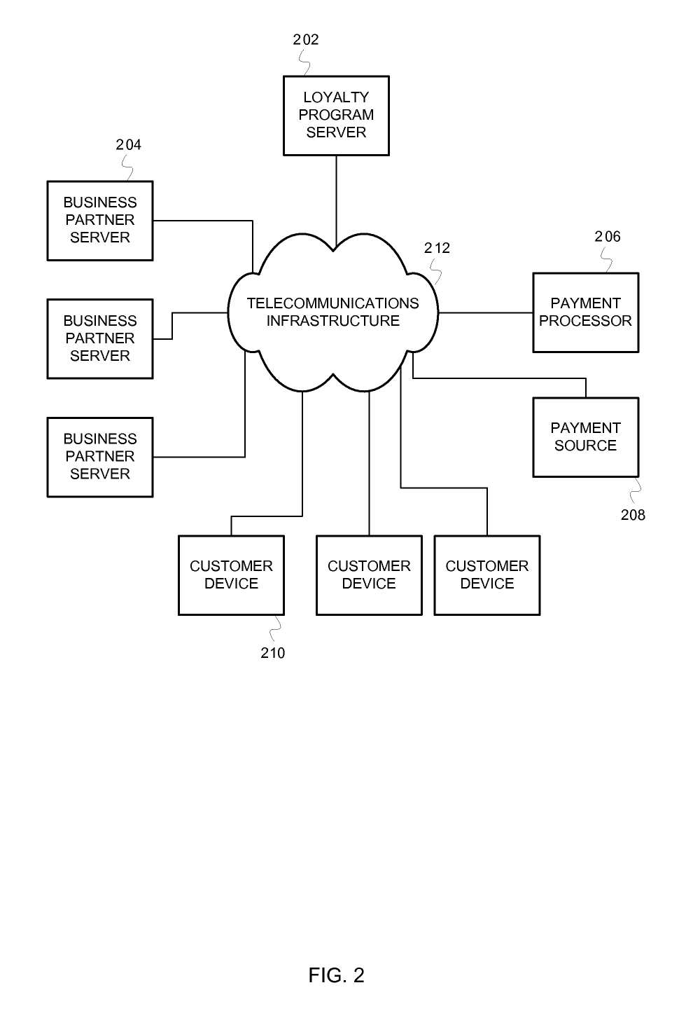

FIG. 1 also shows transactions between the airline loyalty program 104 and the travel service provider 106. In FIG. 1, the airline loyalty program 104 sells miles 116 to the travel service provider 106 for money 114. The travel service provider 106 can use the miles 116 to entice customers to buy travel goods and services. For example, the customer 102 can purchase travel services 118 for money 120. As part of the transaction, travel service provider 106 awards miles 122 to the customer 102. Although not shown in FIG. 1, embodiments of the invention include electronic components that facilitate the transactions (e.g., see FIGS. 2, 8, and 9).

FIG. 1 shows miles flowing to the customer and travel service partner. However, in some embodiments, the miles do not actually move out of accounts managed by the airline loyalty program. For example, upon sale of miles to the travel service partner, the airline loyalty program moves miles into an account (managed by the airline loyalty program) associated with the travel service provider. The same idea may apply to miles accrued by the customer. That is, when the customer accrues miles from the partner or airline loyalty program, miles transfer between accounts managed by the airline loyalty program.

Because the airline loyalty program 104 books travel itineraries for numerous customers, travel service providers can target specific customers that may need particular goods and services. As a result, embodiments of the inventive subject matter provide targeted leads to a loyalty program's business partners, and targeted goods/services to the loyalty program's customers.

### System Components

This section describes an example operating environment and provides structural aspects of some embodiments. After describing some example system components, this section will describe more details about how the system components operate.

In some embodiments, a loyalty program operates one or more computers that conduct transactions and interact with other entities via a telecommunications network. FIG. 2 is a block diagram illustrating a loyalty program server and other computerized components, according to embodiments of the invention. FIG. 2 shows a loyalty program server 202 connected to a telecommunications infrastructure 212. The telecommunications infrastructure 212 can include a local area network (LAN) or a wide area network (WAN). The telecommunications infrastructure 212 can include any suitable technology, such as Public Switched Telephone Network (PSTN), Ethernet, 802.11g, SONET, Wi-Fi, etc.

FIG. 2 also shows business partner servers 204, customer devices 210, a payment source 208 (e.g., a bank), and a payment processor 206 (e.g., a credit card processor).

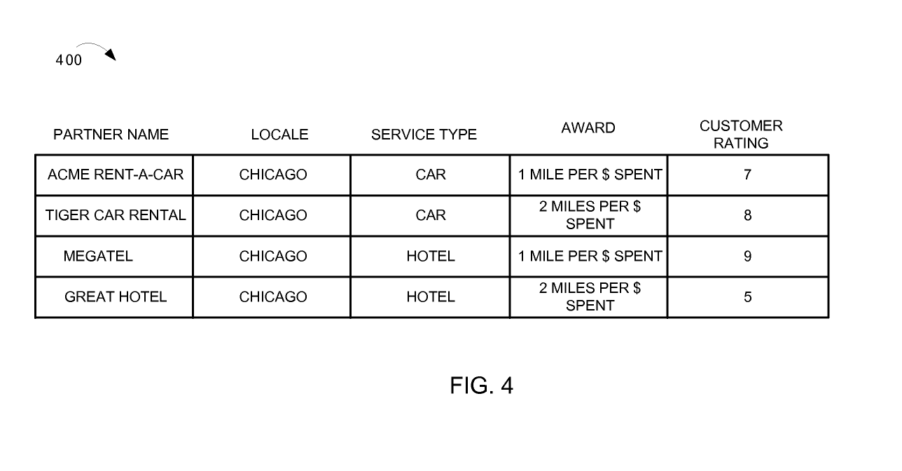

In operation, the loyalty program server 202 can process transactions for goods and services, and transactions that redeem and award loyalty currency (e.g., frequent flyer miles, miles, points, etc.). Additionally, the loyalty program server 202 can process transactions with the business partner servers 204. Such transactions can include offers to become a business partner of the loyalty program (see discussion of FIG. 4). In some instances, the offers can indicate a value proposition, such as a loyalty currency award to be given for customer purchases (e.g., two frequent flier miles per dollar spent on travel services), discounts, favorable service terms, etc. The loyalty program server 202 can also maintain customers' loyalty program accounts.

The business partner servers 204 can process transactions for the sale of goods and services. In some instances, the business partner servers 204 provide electronic interfaces (e.g., web pages) that facilitate transactions with customers via the customer devices 210. When customers purchase travel goods and/or services, the business partner servers 204 can collect payment via the payment processor 206 and/or the payment source 208.

For simplicity, FIG. 2 shows a single loyalty program server 202. In practice, there may be any suitable number of loyalty program servers and other components. The components shown in FIG. 2 can include mainframes, minicomputers, personal computers, laptops, cell phones, personal digital assistants, etc.

### Partnership Offer Processing

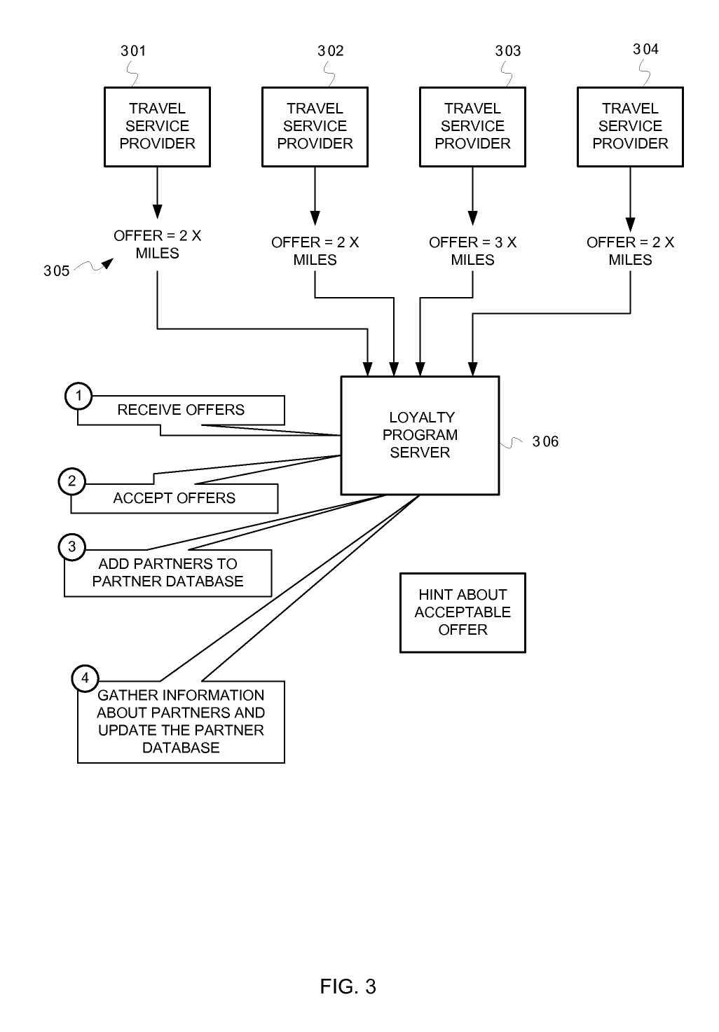

Loyalty programs typically choose business partners that bring a competitive advantage and/or revenue to the loyalty programs. Some embodiments of the invention assist loyalty programs in selecting and administering business partnerships. More specifically, some embodiments provide a mechanism for processing partnership offers from prospective business partners. FIG. 3 shows how some embodiments operate.

FIG. 3 is a conceptual diagram illustrating operations for processing partnership offers, according to some embodiments of the invention. FIG. 3 shows four stages of operations. During stage 1, a loyalty program server 306 receives partnership offers from a number of service providers (e.g., travel service providers). In some embodiments, the loyalty program server 306 provides an electronic interface (e.g., a website) through which travel service providers present their offers. The partnership offers can include value propositions beneficial to the loyalty program and/or its customers. In some instances, the value proposition includes a loyalty currency award for loyalty program customers that do business with the travel service provider. For example, as shown in FIG. 3, travel service providers 301, 302, and 304 offer two miles for every dollar they receive from loyalty program customers. However, the travel service provider 303 offers three miles for every dollar received from loyalty program customers. Assuming all the travel service providers offer equivalent services in the same geographic locations, the offer from travel service provider 303 is best, as it will provide the most value (i.e. the most loyalty currency) for loyalty program customers.

During stage 2, the loyalty program server 306 accepts one or more of the offers. In some embodiments, after the loyalty program server 306 receives a given number of offers from similar service providers (e.g., service providers offering the similar goods and services in similar locations), the loyalty program server 306 accepts one or more of the offers. In some embodiments, administrators can configure the loyalty program server 306 to accept offers based on certain criteria. For example, a loyalty program may want to have an exclusive partner for a particular service type and/or location. To achieve an exclusive partnership, the loyalty program server 306 would accept only one partner for a given service type and/or location. However, if the loyalty program does not desire exclusivity, the loyalty program server 306 can accept more than one offer for a given service type and location.

During stage 3, after accepting offers, the loyalty program server 306 inserts partner information to a partner database. FIG. 4 shows a portion of a partnership database, according to some embodiments. In FIG. 4, a partnership database 400 includes a table that stores information about partners of a loyalty program. As shown, the table includes fields for partner name, location at which the partner operates (locale), type of goods and services the partner offers (service type), award the loyalty program customers will receive by doing business with the partner (award), and other information (e.g., partnership duration, consumer ratings, exclusivity, etc.). The loyalty program server can utilize information in the partnership database for administering existing partnerships, establishing new partnerships, etc. Although not shown, the partnership database 400 can include any suitable information, and can include any suitable number of tables, fields, etc.

Referring back to FIG. 3, operations continue at stage 4. During stage 4, the loyalty program server 306 gathers information about its partners, and stores information in the partner database. For example, the loyalty program server 306 may gather information about how customers rate their partners (e.g., via direct inquiries, third-party information, etc.). In some instances, the loyalty program server 306 can use customer ratings and other information to determine which partners will receive business leads. For example, some embodiments can dynamically award leads based on superior customer service ratings. That is, the server 306 can periodically track customer service ratings, and provide business leads to those partners with the highest service ratings. In other embodiments, the server 306 can make decisions based on other suitable information.

In some embodiments, if an offer is not sufficient, the server 306 can make a counteroffer or provide a hint about what offer is acceptable.

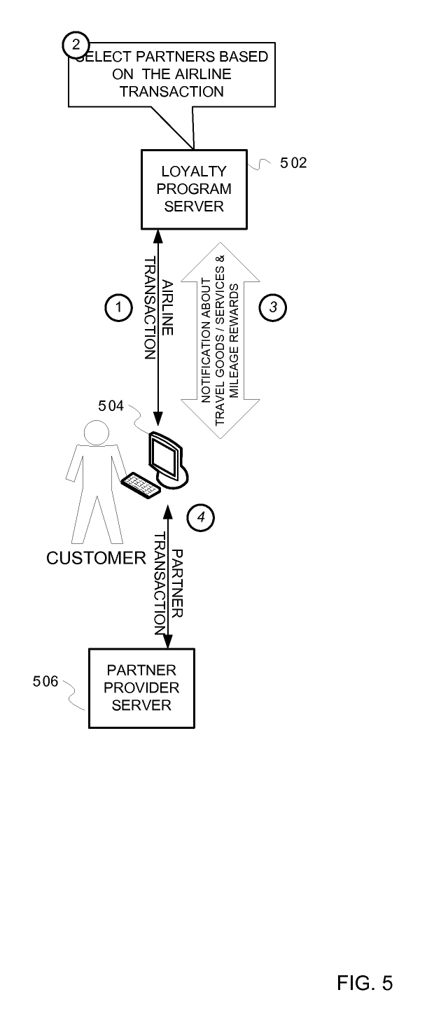

Although some embodiments can process partnership offers as described above, such processing is not required by other embodiments of the inventive subject matter. For example, some embodiments may rely on other means for establishing partnerships and entering partnership information into a partnership database. Thus, so long as loyalty program servers can access partnership information, they can perform other operations described herein (e.g., the operations of FIGS. 5-7).

### More about Transactions

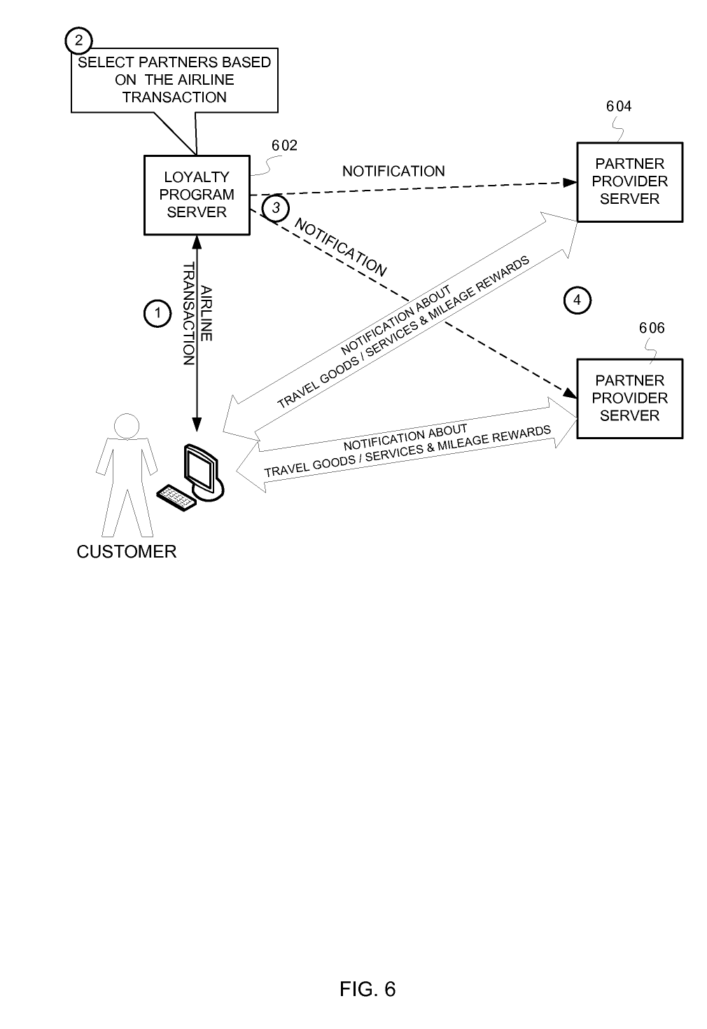

This discussion continues with a description of how some embodiments facilitate transactions between loyalty program customers and partners of the loyalty program. In some embodiments, after a customer purchases services (e.g., airline tickets) from a service provider associated with the loyalty program (e.g., an airline), the loyalty program forwards product offers (e.g., via e-mail) to the customers. However, according to other embodiments, the loyalty program notifies its partners to send offers to customers. FIGS. 5 and 6 describe operations for facilitating such transactions.

FIG. 5 is a conceptual diagram illustrating transactions between a customer, loyalty program, and a loyalty program partner. In FIG. 5, the transactions occur in four stages. During stage 1, a loyalty program customer purchases goods or services from a service provider associated with the loyalty program. For example, a customer purchases airline tickets from an airline associated with loyalty program. As part of the transaction, the loyalty program server 502 records information about the transaction. For example, for an airline ticket purchase, the transaction server 502 may record travel time, travel destination, traveler demographics (age, gender, etc.), and other information related to the transaction. As part of this transaction, the loyalty program may award the customer loyalty currency, such as frequent flyer miles.

During stage 2, the loyalty program server 502 selects one or more partners using information gleaned from the transaction at stage 1. For example, if the customer will be flying to Chicago on December 24th, the loyalty program server 502 searches the partner database for partners operating in Chicago on the given date. In some instances, the server 502 can use the customer's past history to aid in selecting prospective partners. For example, if the customer typically rents an automobile through the loyalty program, the server will select a partner who offers rental car services. In some instances, the server will not use past history, but will select partners that offer services typically needed by loyalty customers.

During stage 3, the loyalty program server 502 notifies the customer about product/service offerings available from its business partners. In some embodiments, the partner database tracks up-to-date product offerings, which are forwarded to loyalty customers (after the customers make purchases via the loyalty program). In some embodiments, the loyalty program server 502 forwards product offerings to the customer via e-mail. In other instances, the server 502 provides the product offerings when the customer accesses a loyalty program website.

During stage 4, the customer purchases products about which the customer received notice. For example, after receiving an e-mail about a special price for a rental car, the customer activates a link (e.g., uniform resource locator) in the e-mail (via the customer computer 504), and electronically books the rental car (e.g., via the partner provider server 506). As part of this transaction, the partner provider awards the customer loyalty currency. In some embodiments, the partner provider server 506 instructs a loyalty program server (not shown in FIG. 5) to credit some amount of loyalty currency to the customer's loyalty account.

Some embodiments operate differently than the embodiment shown in FIG. 5. For example, some embodiments notify the loyalty program's partners about business leads. In turn, the loyalty program's partners can contact loyalty program customers with targeted product offerings. FIG. 6 is a conceptual diagram illustrating transactions between the customer, loyalty program, and a loyalty program partner. In FIG. 6, the transactions occur in four stages. In FIG. 6, stages 1 and 2 are similar to those discussed in FIG. 5. That is, a customer purchases goods/services via a loyalty program server 602 (or other related device). In turn, the loyalty program server 602 selects a partner who offers good/services related to the purchase. If the loyalty program has an exclusive partner who provide services related to the initial purchase, the loyalty program server 602 selects a single partner. Otherwise, the loyalty program server may select a plurality of partners. The server 602 may consult a partner database to facilitate the selection.

During stage 3, the loyalty program server 602 notifies one or more partner provider servers about a business lead. In FIG. 6, the loyalty program server 602 transmits an electronic notification (e.g., email) to the partner provider servers 604 and 606.

During stage 4, the loyalty program partners send product offerings to loyalty program customers. As shown, the partner provider servers 604 and 606 transmit e-mail notifications to the customer, where the e-mails indicate product offerings and associated loyalty currency awards. In other embodiments, partners can use any suitable means to notify customers about product offerings.

### Sale of Loyalty Currency

As noted in the discussion of FIG. 1 (see stage 2), the loyalty program may sell loyalty currency to loyalty program partners. The partners pass-on the loyalty currency to loyalty program customers that do business with the partners. In other words, partners use the loyalty currency to incentivize customers to purchase goods/services from the partners. Some embodiments of the invention facilitate sale of loyalty currency to loyalty program partners.

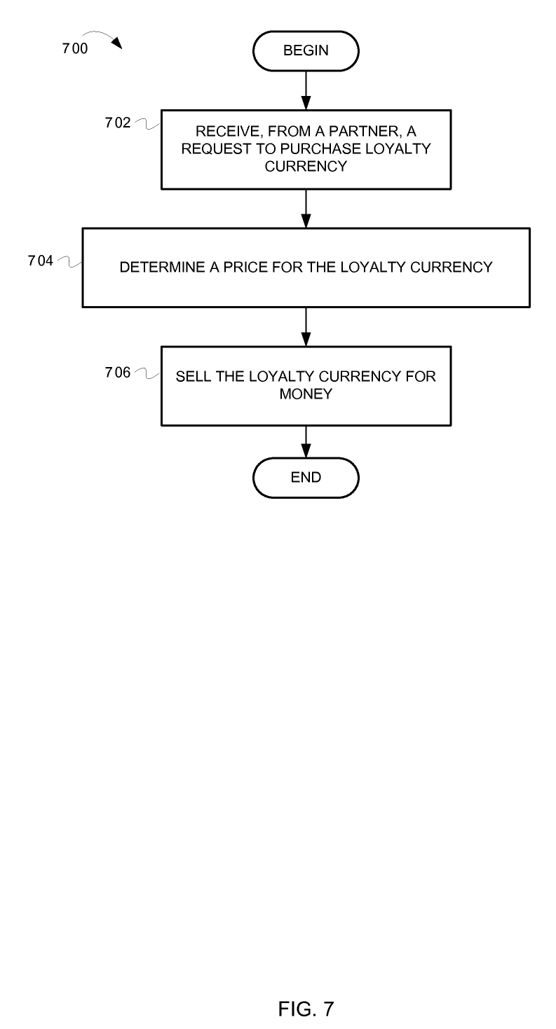

FIG. 7 is a flow diagram illustrating operations for selling loyalty currency to loyalty program partners. In FIG. 7, a flow 700 begins at block 702, where a loyalty program server receives, from a partner, a request to purchase loyalty currency. In some embodiments, the loyalty program server provides an electronic interface (e.g., a website) through which partners can purchase loyalty currency. The flow continues at block 704.

At block 704, the loyalty program server determines a price for the loyalty currency. In some embodiments, the loyalty program server determines the loyalty currency price based on information about the partner. For example, if the partner offers a very high value proposition to loyalty program customers, the loyalty program server may set a relatively low price. In other instances, the loyalty program server can consider other factors (e.g., customer service rating, transaction volume, partnership duration, etc.) when setting a loyalty currency price. In yet other instances, the loyalty program and partner can agree on a price, as part of a partnership agreement (e.g., as part of an offer—see discussion of FIG. 3). The flow continues at block 706.

At block 706, the loyalty program server sells the loyalty currency at the price. In some embodiments, the loyalty program server electronically receives money for the loyalty currency, and deposits the loyalty currency in an account for the partner. In some embodiments, the loyalty program server hosts the partner's loyalty currency account. In other embodiments, partners have facilities for managing their own loyalty currency accounts. From block 706, the flow ends.

### More System Components

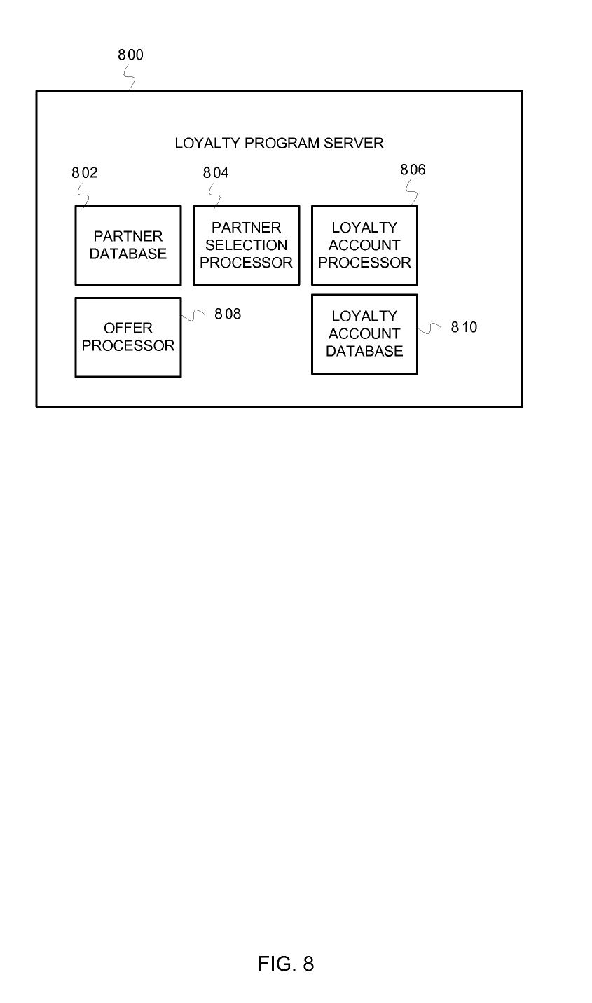

FIG. 8 is a block diagram showing some embodiments of a loyalty program server. In FIG. 8, the loyalty program server 800 includes a partner database 802, partner selection processor 804, loyalty account processor 806, offer processor 808, and loyalty account database 810. In some embodiments, the offer processor 808 can perform the operations described in FIG. 3. That is, the offer processor 808 can process offers and insert information into the partner database 802.

The partner selection processor 804 can select partners that may have product offerings related to a particular customer purchase. For example, for an airline loyalty program, the partner selection processor 804 can select a hotel provider, rental car provider, and tour guide that coincides with a loyalty customer's travel itinerary. In some embodiments, the partner selection processor 804 can utilize the partner database 802.

The loyalty account processor 806 can credit and debit loyalty currency in accounts associated with loyalty program customers and partners. The loyalty account database 810 stores account information. In some embodiments, the loyalty account processor sets a price for loyalty currency (e.g., performs operations shown in FIG. 7).

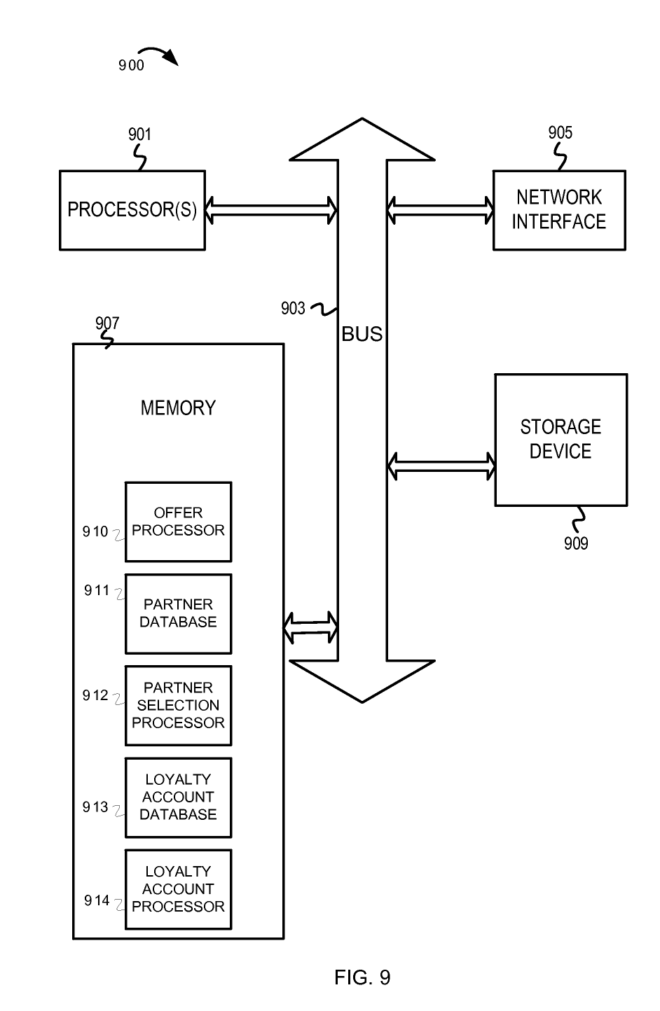

FIG. 9 depicts a more detailed view of an example loyalty program server, according to some embodiments of the inventive subject matter. In FIG. 9, the server includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer system also includes a bus 903 (e.g., PCI, ISA, PCI-Express, HyperTransport®, InfiniBand®, NuBus, etc.), a network interface 905 (e.g., an ATM interface, an Ethernet interface, a Frame Relay interface, SONET interface, wireless interface, etc.), and a storage device(s) 909 (e.g., optical storage, magnetic storage, etc.). The system memory 907 embodies functionality to implement embodiments described above. The memory includes a partner database 910, partner selection processor 911, loyalty account processor 912, offer processor 913, and loyalty account database 914. Any one of these components may be partially (or entirely) implemented in hardware and/or on the processing unit 901. For example, the operations may be implemented with an application specific integrated circuit, in logic implemented in the processing unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

While the embodiments are described with reference to various implementations and exploitations, it will be understood that these embodiments are illustrative and that the scope of the inventive subject matter is not limited to them. In general, techniques described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

As discussed herein, aspects of the present inventive subject matter are described with reference to flowcharts and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In some embodiments, the operations described herein may be represented by instructions stored in a computer readable medium or a plurality of computer readable mediums. A computer readable medium includes a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

### Computer Readable Media

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A computer-implemented method for disseminating a business lead to a partner of a loyalty program, the method comprising:
completing a sales transaction with a customer over a telecommunications network, where the customer is a member of the loyalty program;
depositing, via an electronic transmission, a first quantity of loyalty currency in an electronic account associated with the customer, wherein the deposit is given to the customer for completion of the sales transaction, wherein the loyalty currency is issued by the loyalty program; and
transmitting an electronic notification to the partner, wherein the notification includes information about services purchased via the sales transaction and contact information associated with the customer.

2. The computer-implemented method of claim 1, wherein the contact information associated with the customer includes an email address.

3. The computer-implemented method of claim 1 further comprising:
selling a second quantity of the loyalty currency to the partner via an electronic interface;
redeeming a portion of the second quantity of the loyalty currency from the customer, wherein the customer acquired the portion as a result of purchasing services from the partner.

4. The computer-implemented method of claim 1 further comprising:
receiving, via website, a request to be a business partner of the loyalty program, wherein the request originates from the partner, and wherein the request indicates a value proposition for purchases made from the partner; and
accepting the request to be a business partner of the loyalty program.

5. The computer-implemented method of claim 1 further comprising:
inserting information about the partner into a partner database, wherein the information indicates the value proposition.

6. The computer-implemented method of claim 1, wherein the value proposition includes a virtual currency award for purchases made from the partner.

7. A computer-implemented method for disseminating business leads to a plurality of partners of a loyalty program, the method comprising:
completing, via one or more computers and one or more electronic networks, a sales transaction with a customer, where the customer is a member of the loyalty program;
depositing a quantity of loyalty currency in an account associated with the customer, wherein the deposit is given to the customer for completion of the sales transaction, wherein the loyalty currency is issued by the loyalty program;
selecting one or more of the partners based on information about the sales transaction,
determining services offered by the one or more of the partners, wherein the services are related to the sales transaction; and
transmitting, via the one or more computers and one or more electronic networks, an electronic notification to the customer, wherein the electronic notification identifies the services offered by the one or more partners and a loyalty currency award associated with purchase of the services.

8. The computer-implemented method of claim 7 further comprising:
receiving a request from one of the partners to purchase another quantity of loyalty currency, wherein the request is received through an electronic interface provided by the loyalty program;
determining a price of the other quantity of loyalty currency, wherein the price is based on a transaction history between customers of the loyalty program and the one of the partners;
receiving, from the one of the partners, money equal to the price;
depositing the other quantity of loyalty currency in an account associated with the one of the partners.

9. The computer-implemented method of claim 7, wherein the loyalty program is associated with an airline, wherein the sales transaction is for an airline ticket, and wherein the partners provide travel-related goods and services.

10. The computer-implemented method of claim 9, wherein the information about the sales transaction includes travel dates of the airline ticket, and a travel destination of the airline ticket.

11. The computer-implemented method of claim 7, wherein the electronic notification includes an email message including an internet link to a website at which the customer can purchase the services.

12. The computer-implemented method of claim 7, wherein determining services offered by the one or more of the partners includes querying a database that stores information indicating the services offered by the one or more partners.

13. A computer program product for disseminating business leads to a plurality of partners of a loyalty program, the computer program product comprising:
a computer readable storage medium having computer usable program code embodied therewith, the computer usable program code comprising a computer usable program code configured to:
completing, via one or more computers and one or more electronic networks, a sales transaction with a customer, where the customer is a member of the loyalty program;
depositing a quantity of loyalty currency in an account associated with the customer, wherein the deposit is given to the customer for completion of the sales transaction, wherein the loyalty currency is issued by the loyalty program;
selecting one or more of the partners based on information about the sales transaction,
determining services offered by the one or more of the partners, wherein the services are related to the sales transaction; and
transmitting, via the one or more computers and one or more electronic networks, an electronic notification to the customer, wherein the electronic notification identifies the services offered by the one or more partners and a loyalty currency award associated with purchase of the services.

14. The computer program product of claim 13, wherein the program code is further configured to:
receiving a request from one of the partners to purchase another quantity of loyalty currency, wherein the request is received through an electronic interface provided by the loyalty program;
determining a price of the other quantity of loyalty currency, wherein the price is based on a transaction history between customers of the loyalty program and the one of the partners;
receiving, from the one of the partners, money equal to the price;
depositing the other quantity of loyalty currency in an account associated with the one of the partners.

15. The computer program product of claim 13, wherein the loyalty program is associated with an airline, wherein the sales transaction is for an airline ticket, and wherein the partners provide travel-related goods and services.

16. The computer program product of claim 13, wherein the information about the sales transaction includes travel dates of the airline ticket, and a travel destination of the airline ticket.

17. The computer program product of claim 13, wherein the electronic notification includes an email message including an internet link to a website at which the customer can purchase the services.

18. The computer program product of claim 13, wherein the determining services offered by the one or more of the partners includes querying a database that stores information indicating the services offered by the one or more partners.
